(19) United States
(12) Patent Application Publication
(10) Pub. No.: US 2002/0118449 A1
(43) Pub. Date: Aug. 29, 2002

(54) Device and method for controlling the brightness or color of a superimposed image in an optical viewing device

(75) Inventor: Roger Spink, Berneck (CH)

Correspondence Address: Glenn Law, FOLEY & LARDNER, Washington Harbour, 3000 K Street, N.W., Suite 500, Washington, DC, 20007-5143, US

(73) Assignee: LEICA MICROSYSTEMS AG

(21) Appl. No.: 10/024,278

(22) Filed: Dec. 21, 2001

(30) Foreign Application Priority Data
Dec. 23, 2000 (DE) 100 64 909.2

(51) Int. Cl. G02B 21/00; G02B 21/18; G02B 27/10

(52) U.S. Cl. 359/368; 359/618; 359/373

(57) ABSTRACT

A device for controlling a characteristic of an image signal superimposed on a specimen image includes: a main optical system configured to refract light emitted from a specimen into a main beam path; a superimposition apparatus in a fixed relationship to the main optical system, configured to generate the image signal; a superimposing reflector configured to reflect the image signal generated by the superimposition apparatus into the main beam path and to superimpose the image signal onto the specimen image; an image measurement unit in a fixed relationship to the main optical system configured to measure a characteristic of the specimen image; and a controller configured to adjust a characteristic of the image signal generated by the superimposition apparatus in response to a measurement by the image measurement unit. The characteristic of the specimen image and the characteristic of the image signal may be brightness, color, or contrast.

### CROSS REFERENCE TO RELATED APPLICATIONS

This invention claims priority of the German patent application 100 64 909.2, filed Dec. 23, 2000, which is incorporated by reference herein.

### FIELD OF THE INVENTION

The invention concerns an optical viewing device, such as a surgical stereomicroscope or other type of microscope, in which an image signal or data are superimposed on a specimen image.

### BACKGROUND OF THE INVENTION

Overlaying of data, or the superimposition of data by means of reflecting-in or superimposition devices, into the observation field of optical systems is being used more and more in many sectors, because it results in a considerable gain in information. In clinical applications, it gives the surgeon the possibility of receiving further visual information without interrupting his or her visual contact with the surgical field. While viewing the situs through the microscope the surgeon can, for example, perceive the location and size of the target specimen, typically by overlaying or superimposing additional data (e.g., virtual-reality specimen contours) onto the microscopic intermediate image by means of a display, an optical system, and a superimposing reflector.

In almost all applications, the brightness, contrast, and resolution of the overlaid image are important quality features for proper functionality. For good perception of the overlaid information, the image signal that is superimposed or reflected in must be significantly brighter than the optical image (e.g., of a specimen). It must not be too bright, however, so as to interfere with viewing of the specimen because of dazzle or glare.

In reflecting-in devices known at present, the image of a corresponding monitor or liquid crystal display (LCD) screen is imaged via a lens system and a splitter prism or superimposing reflector into the intermediate image of the microscope, and overlaid on the image obtained by the main objective. The brightness and contrast of the reflected-in image are usually neither controlled nor regulated.

### SUMMARY OF THE INVENTION

The inventor has recognized that conventional systems are disadvantageous in terms of the following aspects. The fixed brightness of the reflected-in image can result in glare or in “submersion” of the specimen image so that it is difficult or impossible to view the specimen, the reflected-in image, or both. Previously, manual control of brightness and contrast could be accomplished only over the entire image, but not over individual regions or pixels. In other words, because of varying light reflectivity over the area of a typical specimen, some regions will be brighter than others at a given brightness level. As a result, manually adjusting the brightness to prevent glare and submersion of the specimen image and/or the reflected-in image in one region of the specimen may result in glare or submersion of the specimen image and/or the reflected-in image in another region(s) of the specimen. Therefore, in order to view an entire specimen, it may be necessary to constantly readjust the brightness of the specimen and/or reflected-in image. Consequently, when there are differences in image characteristics (e.g., reflectivity and brightness), manual regulation of brightness and contrast may result in laborious adaptations and adjustments while viewing.

It is therefore an object of the invention to find an improvement which eliminates the aforesaid disadvantages and makes possible undisturbed, continuous viewing of the reflected-in information, independently of the brightness and contrast of the specimen being imaged.

For the process of controlling the superimposed image, the basic brightness of the specimen image is ascertained by detection of the specimen, for example by means of a charge coupled device (CCD) or a video camera, as is the spatial distribution of brightness and/or color. Adjustment of the basic brightness can then be accomplished, for example in the case of an LCD or a monitor, by regulating the illuminating light source, and the brightness of each pixel can also be regulated on the basis of the ascertained specimen brightness and/or color at the corresponding pixel location.

According to the present invention, at least the following improvements can therefore be achieved. The brightness of all the reflected-in information may be adapted to the specimen brightness. The brightness of the reflected-in information may be adapted, pixel by pixel, to the brightness of the corresponding pixels or individual regions of the specimen image. The overall brightness of the image may be adapted continuously and automatically. Adaptation to the brightness or contrast of the image may be performed automatically, either zone by zone or pixel by pixel. In general, the suppression of dark areas and the occurrence of glare in the specimen image are thereby prevented without manual intervention. The overall brightness and overall contrast of the reflected-in image can also, if necessary, be controlled manually and/or (optionally) by remote control by the respective viewer.

A particular advantage of the present invention is that not only the brightness of the reflected-in image, but also the color, may be adapted to the particular specimen brightness and/or color. For example, a color contrasting with the particular specimen image may be used for the reflected-in image.

In a preferred embodiment, the present invention provides for a device for controlling a characteristic of an image signal superimposed on a specimen image, comprising: a main optical system configured to refract light emitted from a specimen into a main beam path; a superimposition apparatus, which may be a display or monitor, in a fixed relationship to the main optical system, configured to generate the image signal; a superimposing reflector configured to reflect the image signal generated by the superimposition apparatus into the main beam path and to superimpose the image signal onto the specimen image; an image measurement unit, which may be a video camera or CCD, in a fixed relationship to the main optical system, configured to measure a characteristic of the specimen image; and a controller configured to adjust a characteristic of the image signal generated by the superimposition apparatus in response to a measurement by the image measurement unit. The characteristic of the specimen image and the characteristic of the image signal may be brightness, color, or contrast, and the image measurement unit may be configured to measure a spatial brightness distribution of the specimen image or a spatial color or contrast distribution of the specimen image.

In a preferred aspect of the present invention, the image measurement unit may be configured to measure the characteristic of the specimen image by directly measuring light emitted from the specimen and not refracted by the main optical system. Alternatively, the image measurement unit may be configured to measure the characteristic of the specimen image by measuring light emitted from the specimen and refracted by the main optical system into the main beam path. The device may further comprise a beam splitter configured to reflect a portion of the specimen image from the main beam path to the image measurement unit.

In another preferred aspect of the present invention, the image measurement unit may be configured to measure a characteristic of the entire specimen image. Alternatively, the image measurement unit may be configured to measure characteristics of individual regions, such as individual pixels, of the specimen image. The image measurement unit may be configured to measure characteristics of those individual regions that are in a viewer's line of sight.

In another preferred aspect of the present invention, the controller may be configured to adjust a characteristic of the entire image signal generated by the superimposition apparatus in response to the measurement by the image measurement unit. Alternatively, the controller may be configured to adjust characteristics of individual regions, such as individual pixels, of the image signal generated by the superimposition apparatus in response to the measurement by the image measurement unit.

In another preferred aspect of the present invention, the controller may be configured to adjust characteristics of individual regions, such as individual pixels, of the image signal generated by the superimposition apparatus in response to measurements by the image measurement unit of the characteristics of the corresponding regions, such as pixels, of the specimen image.

In another preferred aspect, the present invention may further comprise a manual input unit for providing a manual input signal from a viewer to the controller, wherein the controller is configured to adjust the characteristic of the image signal generated by the superimposition apparatus in response to the manual input signal and the measurement by the image measurement unit. The manual input unit may be operable remotely from the device.

In another preferred embodiment, the present invention provides for a method for controlling a characteristic of an image signal superimposed on a specimen image, comprising: providing a specimen; producing a specimen image for viewing by a viewer; measuring a characteristic of the specimen image; generating a control signal based at least in part on the characteristic of the specimen image; producing an image signal having a characteristic that is controlled by the control signal; and superimposing the image signal on the specimen image for viewing by the observer. The characteristic of the specimen image and the characteristic of the image signal may be brightness, color, or contrast.

In a preferred aspect of the present invention, measuring a characteristic of the specimen image may include reflecting a portion of the specimen image via a beam splitter toward an image measurement unit.

In another preferred aspect of the present invention, producing an image signal may include producing an image signal having individual regions, such as individual pixels, wherein characteristics of the individual regions are controlled by the control signal.

### BRIEF DESCRIPTION OF THE DRAWINGS

The invention will be explained in more detail below with reference to the drawings.

FIG. 1 is a schematic drawing of a preferred embodiment of the present invention.

FIG. 2 is a schematic drawing of a preferred embodiment of the present invention showing directions of light passage.

FIG. 3 is a graph showing an approximate plot of the brightness of the reflected-in image as a function of the brightness of the specimen image.

### DETAILED DESCRIPTION OF THE INVENTION

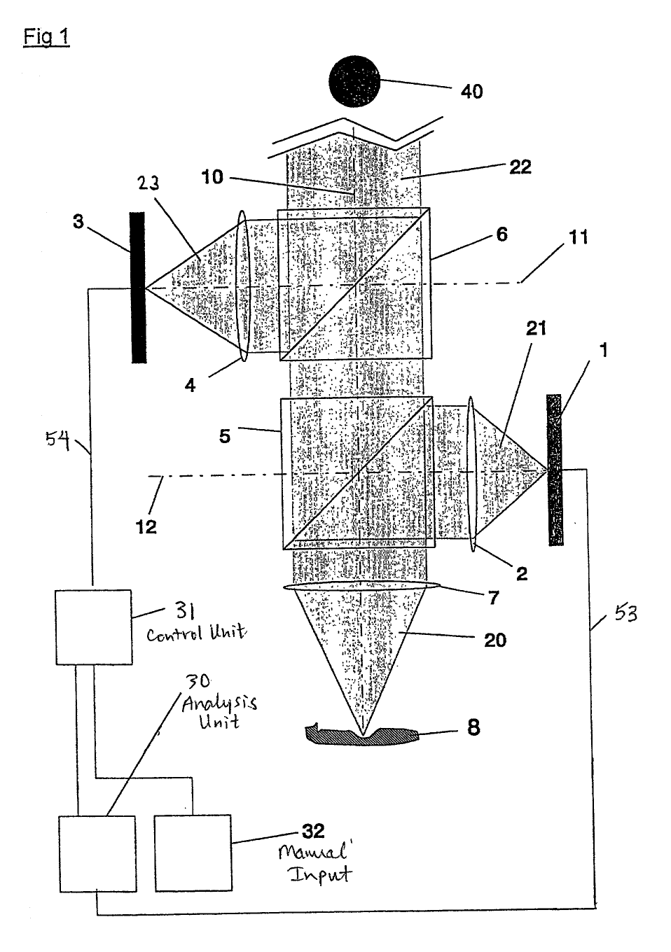

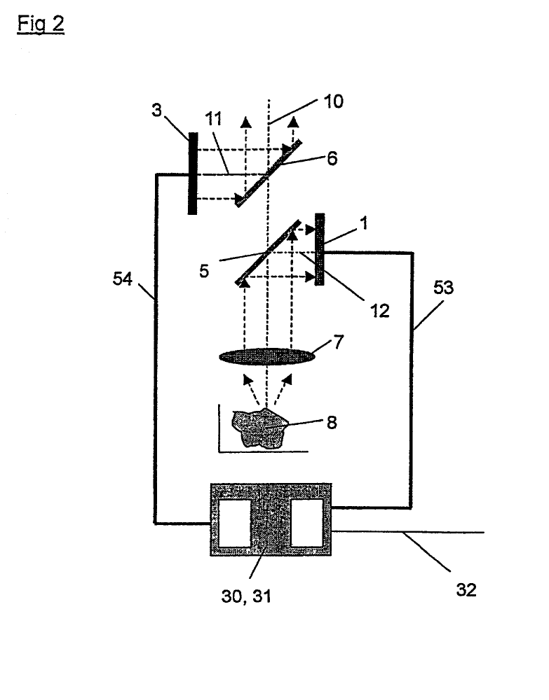

Referring to FIGS. 1 and 2, in a preferred embodiment of a device for viewing a specimen 8, a main beam path 20, 22 (comprising a specimen beam path 20 and an eyepiece beam path 22) extends in an upward direction (toward a viewer 40) along an axis 10. The specimen beam path 20 is focused or refracted by main optical system 7 into eyepiece beam path 22 so that specimen 8 may be viewed by viewer 40.

A portion of the main beam path 20, 22 is deflected along an axis 12 toward the image brightness and contrast measurement device 1 by splitting main beam path 20,22 above the main optical system 7 using a measurement beam splitter 5. This deflected portion is then focused or refracted by measurement optical system 2 to form a measurement beam path 21 of an image measurement device 1. Image measurement device 1 may, for example, be a CCD or a video camera. The measurement beam splitter may be a partially reflective mirror, such that part of the rays incident on it will pass through, and the other part will be reflected.

A superimposition device 3 provides data or information to be superimposed or reflected into the main beam path 20, 22 for viewing by viewer 40. Superimposition beam path 23 of reflected-in data is focused or refracted by superimposition optical system 4 and deflected from an axis 11 into the main beam path 20, 22 by superimposing reflector 6, thus resulting in the superimposition or reflection of data or information into the main beam path 20, 22. A superimposition apparatus 3 may be, for example, a display device or monitor. Superimposing reflector 6 allows light incident from one side to pass through but reflects light rays incident from the other side.

According to a preferred embodiment of the present invention, the control system includes: superimposition apparatus 3 which provides the reflected-in data/information to the viewer 40 via superimposition optical system 4 and superimposing reflector 6; image measurement device 1 which measures the brightness, contrast, and/or color information of the specimen 8 via measurement beam splitter 5 and measurement optical system 2; measurement signal 53 which carries measurement information as measured by the image measurement device 1; manual input 32 which provides manual input information; analysis unit 30 (contained in, for example, a computer or processor) which analyzes the measurement information from the measurement signal 53; and control unit 31 (contained in, for example, the same computer as the analysis unit 30) which provides a control signal 54 to the superimposition apparatus 3 based on information from the analysis unit 30 and the manual input information from the manual input 32. The brightness, contrast, or color of the superimposed data/image generated by the superimposition apparatus 3 is adjusted according to the control signal 54.

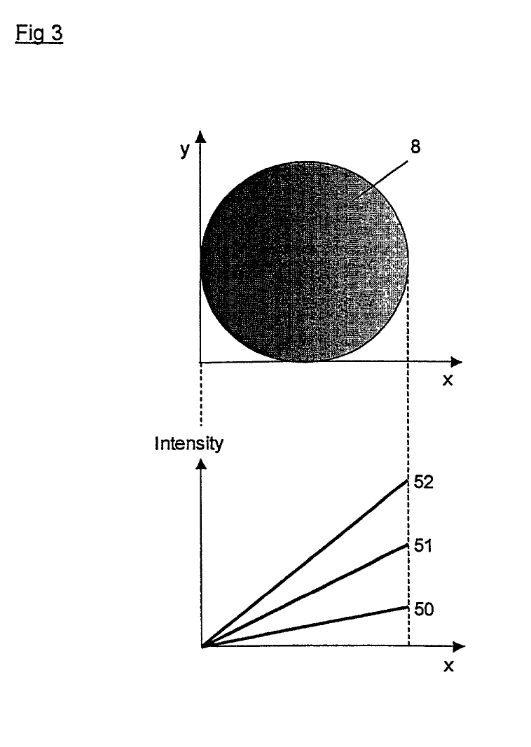

Referring now to FIG. 3, the effect of a control system according to the present invention will be described. The x, y pixels of an image of a specimen 8 have a brightness as shown, for example, in curve 50. In the interest of an easily visible overlay or superimposition, the brightness or intensity of the superimposed image is regulated, by way of analysis and control units 30, 31, in accordance with curve 51 so as to yield a total brightness according to curve 52. The brightness and/or contrast is thus adapted suitably and automatically. The color may also be adapted in order to increase contrast between the specimen image and the superimposed image. Thus the control system has the effect of automatically adjusting the brightness and/or color of the superimposed data/image in relation to the brightness and/or color of the image of the specimen 8—e.g., increasing the brightness of the superimposed data where the image of the specimen 8 is very bright, and decreasing the brightness of the superimposed data where the image of the specimen 8 is very dull.

A preferred operation of the present invention will now be described. A portion of specimen beam path 20 proceeding from specimen 8 through main optical system 7 is deflected by means of measurement beam splitter 5 to the image measurement device 1, for example a CCD or a video camera. Measurement signal 53 from the image measurement device 1 is forwarded to an analysis unit 30.

By means of the analysis unit 30, the total brightness and/or color of the specimen image and the spatial distribution of brightness and/or color within the image are determined zone by zone (i.e., region by region, where each zone or region has more than one pixel but comprises less area than the entire specimen image) or pixel by pixel. On the basis of this determination of brightness and/or color, as well as input information from the manual input 32, the control unit 31 provides a control signal 54 to the superimposition apparatus 3. The control unit 31 via the control signal 54 controls the brightness and/or color of the superimposed data on the basis of the brightness and/or color of the image of the specimen 8 and its individual pixels and/or regions.

This brightness- and contrast-controlled superimposition information is then generated by superimposition apparatus 3 and reflected into main beam path 20, 22 through the superimposition optical system 4 and superimposing reflector 6.

Either a self-luminous or a non-self-luminous superimposition apparatus 3 can be used in the context of the invention. A “superimposition apparatus” is to be understood, for purposes of the invention, as any apparatus that delivers optical data, and may include laser displays or the like.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described to explain the principles of the invention and as a practical application to enable one skilled in the art to utilize the invention in various embodiments and with various modifications suited to the particular use contemplated. It is intended that the scope of the invention be defined by the claims appended hereto and their equivalents.

PARTS LIST

| | |
|---|---|
| 1 | Image brightness and contrast measurement device (e.g., video |
| | camera or CCD) |
| 2 | Measurement optical system |
| 3 | Superimposition apparatus (e.g., display, monitor) |
| 4 | Superimposition optical system |
| 5 | Measurement beam splitter |
| 6 | Superimposing reflector |
| 7 | Main optical system |
| 8 | Specimen |
| 10 | Axis of main beam path |
| 11 | Axis of superimposition beam path |
| 12 | Axis of measurement beam path |
| 20 | Specimen beam path |
| 21 | Measurement beam path |
| 22 | Eyepiece beam path |
| 23 | Superimposition beam path |
| 30 | Analysis unit |
| 31 | Control unit |
| 32 | Manual input |
| 40 | Viewer |
| 50 | Brightness of specimen image |
| 51 | Brightness of superimposed image |
| 52 | Total brightness |
| 53 | Measurement signal |
| 54 | Control signal |

What is claimed is:

1. A device for controlling a characteristic of an image signal superimposed on a specimen image, comprising:
a main optical system configured to refract light emitted from a specimen into a main beam path;
a superimposition apparatus in a fixed relationship to the main optical system, configured to generate the image signal;
a superimposing reflector configured to reflect the image signal generated by the superimposition apparatus into the main beam path and to superimpose the image signal onto the specimen image;
an image measurement unit in a fixed relationship to the main optical system, configured to measure a characteristic of the specimen image; and
a controller configured to adjust a characteristic of the image signal generated by the superimposition apparatus in response to a measurement by the image measurement unit of the characteristic of the specimen image.

2. The device as in claim 1, wherein the characteristic of the specimen image and the characteristic of the image signal are brightness.

3. The device as in claim 2, wherein the image measurement unit is configured to measure a spatial brightness distribution of the specimen image.

4. The device as in claim 1, wherein the characteristic of the specimen image and the characteristic of the image signal are one of color and contrast.

5. The device as in claim 4, wherein the image measurement unit is configured to measure a spatial color or contrast distribution of the specimen image.

6. The device as in claim 1, wherein the superimposition apparatus is one of a display and monitor.

7. The device as in claim 1, wherein the image measurement unit is configured to measure the characteristic of the specimen image by directly measuring light emitted from the specimen and not refracted by the main optical system.

8. The device as in claim 1, wherein the image measurement unit is configured to measure the characteristic of the specimen image by measuring light emitted from the specimen and refracted by the main optical system into the main beam path.

9. The device as in claim 8, further comprising a beam splitter configured to reflect a portion of the specimen image from the main beam path to the image measurement unit.

10. The device as in claim 1, wherein the image measurement unit is configured to measure a characteristic of the entire specimen image.

11. The device as in claim 1, wherein the image measurement unit is configured to measure characteristics of individual regions of the specimen image.

12. The device as in claim 11, wherein the individual regions are individual pixels.

13. The device as in claim 11, wherein the image measurement unit is configured to measure characteristics of those individual regions that are in a viewer's line of sight.

14. The device as in claim 1, wherein the controller is configured to adjust a characteristic of the entire image signal generated by the superimposition apparatus in response to the measurement by the image measurement unit.

15. The device as in claim 1, wherein the controller is configured to adjust characteristics of individual regions of the image signal generated by the superimposition apparatus in response to the measurement by the image measurement unit.

16. The device as in claim 15, wherein the individual regions are individual pixels.

17. The device as in claim 16, wherein the controller is configured to adjust characteristics of individual pixels of the image signal generated by the superimposition apparatus in response to measurements by the image measurement unit of the characteristics of the corresponding pixels of the specimen image.

18. The device as in claim 15, wherein the controller is configured to adjust characteristics of individual regions of the image signal generated by the superimposition apparatus in response to measurements by the image measurement unit of the characteristics of the corresponding regions of the specimen image.

19. The device as in claim 1, further comprising a manual input unit for providing a manual input signal from a viewer to the controller, wherein the controller is configured to adjust the characteristic of the image signal generated by the superimposition apparatus in response to the manual input signal and the measurement by the image measurement unit.

20. The device as in claim 19, wherein the manual input unit is operable remotely from the device.

21. The device as in claim 1, wherein the image measurement device is one of a video camera and a CCD.

22. A method for controlling a characteristic of an image signal superimposed on a specimen image, comprising:
providing a specimen;
producing a specimen image for viewing by a viewer;
measuring a characteristic of the specimen image;
generating a control signal based at least in part on the characteristic of the specimen image;
producing an image signal having a characteristic that is controlled by the control signal; and
superimposing the image signal on the specimen image for viewing by the viewer.

23. The method as in claim 22, wherein the characteristic of the specimen image and the characteristic of the image signal are one of brightness, color, and contrast.

24. The method as in claim 22, wherein measuring a characteristic of the specimen image comprises reflecting a portion of the specimen image via a beam splitter toward an image measurement unit.

25. The method as in claim 22, wherein producing an image signal comprises producing an image signal having individual regions, wherein characteristics of the individual regions are separately controlled by the control signal.

26. The method as in claim 25, wherein the individual regions are individual pixels.

27. A device for controlling a characteristic of an image signal superimposed on a specimen image, comprising:
a microscope configured to produce a specimen image;
a superimposition apparatus in a fixed relationship to the microscope, configured to generate the image signal; and
an image measurement unit in a fixed relationship to the microscope, configured to measure a characteristic of the specimen image, wherein a characteristic of the image signal generated by the superimposition apparatus is automatically adjusted in response to a measurement by the image measurement unit of the characteristic of the specimen image.

28. The device as in claim 27, wherein the microscope is a surgical stereomicroscope.

29. The device as in claim 27, wherein the characteristic of the specimen image and the characteristic of the image signal are brightness.

30. The device as in claim 27, wherein the characteristic of the specimen image and the characteristic of the image signal are one of color and contrast.

31. The device as in claim 27, wherein characteristics of individual regions of the image signal generated by the superimposition apparatus are individually adjusted in response to measurements by the image measurement unit of characteristics of corresponding regions of the specimen image.

32. The device as in claim 31, wherein the individual regions of the image signal and the corresponding regions of the specimen image are pixels.
